(19) United States
(12) Patent Application Publication
(10) Pub. No.: US 2006/0085124 A1
(43) Pub. Date: Apr. 20, 2006

(54) Navigation device

(75) Inventor: Tsunekimi Suzuki, Chiryu-city (JP)

Correspondence Address: POSZ LAW GROUP, PLC, 12040 SOUTH LAKES DRIVE, SUITE 101, RESTON, VA, 20191, US

(73) Assignee: DENSO CORPORATION

(21) Appl. No.: 11/231,849

(22) Filed: Sep. 22, 2005

(30) Foreign Application Priority Data
Oct. 19, 2004 (JP) 2004-304839

(51) Int. Cl. G01C 21/34

(52) U.S. Cl. 701/211; 701/209; 340/995.19

(57) ABSTRACT

It is determined whether an access to a map database is possible. When the access is possible, a route to an entry point designated by a user is constantly retrieved; then, route information relating to the retrieved route is stored. In contrast, when the access is impossible because of malfunction of the map database, a route guidance to the entry point is performed using the stored route information. This enables a route guidance to a point where the user wants to go even when the access to the map database becomes disabled.

### CROSS REFERENCE TO RELATED APPLICATIONS

This application is based on and incorporates herein by reference Japanese Patent Application No. 2004-304839 filed on Oct. 19, 2004.

### FIELD OF THE INVENTION

The present invention relates to a navigation device, a route guidance method of a navigation device, or a program used in a navigation device.

### BACKGROUND OF THE INVENTION

There is a known navigation device that can provide map data necessary for a driver or various devices when peripherals of a map database become abnormal (refer to Patent Document 1). In a normal state, the navigation device described in Patent Document 1 constantly reads out emergency map data enabling an approach to a repair shop from a current position and then stores the read emergency map data. In an abnormal state of an ECU of the navigation device, the navigation device retrieves a route from a current position to a given support center (or repair shop) using the previously stored emergency map data and then performs a route guidance to the given support center by displaying the retrieved route on a display unit.
Patent Document 1: JP-H10-160502 A

Thus, this navigation device is designed for retrieving a route to a support center included in the previously stored emergency map data and then performing a route guidance by displaying the retrieved route, in an abnormal state of peripherals of the map database. This considers a navigation system that performs vehicle traveling control assistance (e.g., transmission control or throttle control) based on map data; therefore, abnormality in reading out the map database causes stopping of information necessary for vehicle traveling control. Consequently, the conventional navigation device prioritizes the route guidance to a support center within the emergency map data to anticipate the stopping of information necessary for vehicle traveling.

However, for instance, guiding the relevant vehicle to a support center outside office hours such as nonbusiness days, midnights, or early mornings does not assure a quick repair. Therefore, a user feels uneasy. Furthermore, when a user at first goes to a given place different from the support center, a route guidance to the given place cannot be performed in preference to the route guidance to the support center. As a result, since the conventional navigation device is designed for performing a route guidance to a support center within emergency map data, the user cannot be guided to another place where the user wants to go and that the emergency map data does not include. This poses a problem.

### SUMMARY OF THE INVENTION

It is an object of the present invention to provide a navigation device, a route guidance method of a navigation device, and a program used in a navigation device, all of which are capable of solving the above problem. Namely, even when an access to a map database becomes impossible, the navigation device of the present invention enables a route guidance to a point where a user wants to go.

To achieve the above object, a navigation device is provided with the following: A route retrieval unit is included for retrieving a route to a destination using map data stored in a map database. A guidance unit is included for guiding a user along the retrieved route to the destination. An entry point storing unit is included for storing a point designated by the user as an entry point. A determination unit is included for determining whether an access to the map database is enabled. An entry point route retrieval unit is included for retrieving a route to the entry point using the map database when the access to the map database is determined to be enabled. A route information storing unit is included for storing route information relating to the retrieved route. Furthermore, an entry point route guidance unit is included for guiding the user along the retrieved route to the entry point using the stored route information when the access to the map database is determined to be not enabled.

Under this structure of the navigation device of the present invention, a route to an entry point a user designates is constantly retrieved while an access to a map database is possible; route information relating to the retrieved route is stored in a route information storing unit. Thereafter, even when the access to the map database becomes impossible, a route guidance to an entry point from a position that is the last point where the access to the map database is still possible can be performed using the stored route information. This enables a route guidance to a point where a user wants to go even when an access to the map database is disabled.

### BRIEF DESCRIPTION OF THE DRAWINGS

The above and other objects, features, and advantages of the present invention will become more apparent from the following detailed description made with reference to the accompanying drawings. In the drawings:

FIG. 1 is a block diagram of an overall structure of a navigation device according to an embodiment of the present invention;

FIG. 2 is a flowchart diagram of an entry point route guidance process;

FIG. 3 is an exemplified display image shown when an access to a map database becomes disabled;

FIG. 4A is an exemplified display image in a TBT mode; and

FIG. 4B is an exemplified display image in an expressway mode.

### DETAILED DESCRIPTION OF THE PREFERRED EMBODIMENTS

The present invention is adapted to a navigation device, a method for a navigation device, or a program for a navigation device. In detail, an embodiment of the present invention is adapted to one function of a navigation device 100 mounted in a subject vehicle.

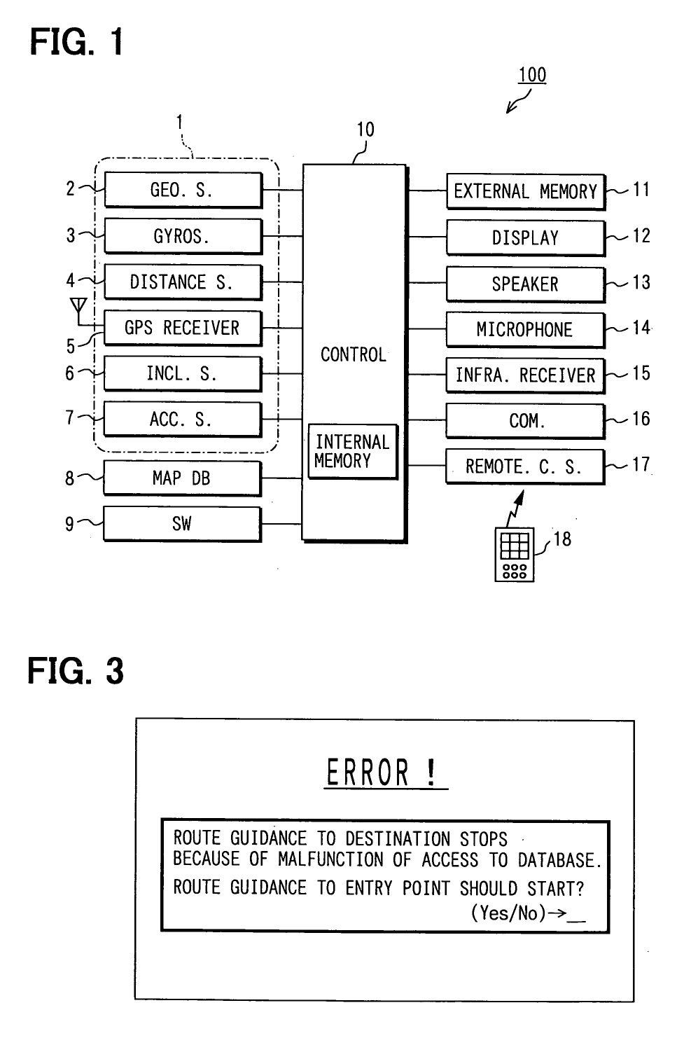

As shown in FIG. 1, the navigation device 100 includes a position detector 1, a map data input unit (or map database) 8, an operation switch group 9, a control circuit 10, an external memory 11, a display unit 12, a speaker 13, a microphone 14 for inputting voices, an infrastructure receiver 15, a communications unit 16, a remote controller sensor 17, and a remote controller 18.

The control circuit 10 is a known computer that includes an internal memory (e.g., a non-volatile memory), a CPU, a ROM, a RAM, an I/O, and a bus line connecting the foregoing components. The ROM includes a program the control circuit 10 executes. The CPU or the like executes given computation processes using the programs.

The position detector 1 includes a geomagnetism sensor 2 for detecting an advancing direction of the subject vehicle, a gyro sensor 3 for detecting an angle speed relative to a vertical axis of the subject vehicle, a distance sensor 4 for detecting a movement distance of the subject vehicle, a GPS receiver for detecting a current position of the subject vehicle based on radio waves from satellites, an inclination sensor 6 for detecting a rolling angle, a pitch angle, a yaw angle of the subject vehicle, and an acceleration sensor 7 for detecting an acceleration in a back-and-forth direction, a lateral direction, and a vertical direction of the subject vehicle. These sensors or the like have individual characteristic errors; thereby, these sensors or the like are used while being complemented by each other. Furthermore, only some of them can be used depending on a required accuracy level. Alternatively, a rotation sensor of steering, or a vehicle speed sensor for detecting a vehicle speed from a rotation speed of each following wheel can be used.

The map database 8 is used for inputting map data including road data, index data, drawing data, or the like. A storage medium for storing the database can be a read-only storage medium of a CD-ROM, a DVD-ROM, or the like; or a writable storage medium of a memory card, a hard disk, or the like.

The road data includes link data and node data. A node is an intersection, a branching point, a merging point, or the like. A link is defined to be a road portion between nodes; therefore, connecting links causes a road.

The link data includes a unique number (link ID) for identifying a link, a link length of the link, starting and ending coordinates (latitudes and longitudes) of the link, a road name of the link, a road kind (expressway, toll road, national road, prefectural road, or the like) of the link, a road width of the link, a necessary traveling time period (on foot, or by car) of the link, or the like.

The node data includes a unique number (node ID) for identifying a node; node coordinates (latitude and longitude) of the node; connecting link IDs of all links connecting to the node; a point attribute for indicating a branching point, a merging point, or an intersection; a name (intersection name for an open road, an interchange name or junction name for an expressway or toll road, or the like) of the node, or the like.

The index data is used for retrieving a facility or the like, and includes names, kinds, addresses, phone numbers, positions (latitudes and longitudes), or the like, with respect to facilities, roads, or nodes.

The drawing data is used for displaying maps, and includes display characters, display positions (latitudes and longitudes), polygons, land marks, or the like, with respect to land features (seas, lakes, ponds, mountains, or the like), roads, or nodes.

The operation switch group 9 is, for instance, a touch switch integrated to the display unit 12, or a mechanical switch, to be used for various inputs. The external memory 11 includes a read/write storage medium such as a memory card.

The display unit 12 is, for instance, a liquid crystal display, and displays a road map and a current position mark on its screen. The road map is formed using map data inputted from the map database 8 and shows a vicinity of the current position of the subject vehicle. The current position mark shows the current position of the subject vehicle inputted from the position detector 1.

The speaker 13 is used for voice guidance or the like. The microphone 14 is used for a user to voice input. The communications unit 16 is used for communicating with an outside of the subject vehicle. For instance, the unit 16 is able to connect to the Internet or a dedicated line.

The infrastructure receiver 15 is for receiving various information from an external infrastructure. For instance, the receiver 15 is a VICS receiver to receive road traffic information from a center of the VICS (Vehicle Information and Communication System, registered trademark) via road-installed beacons or local FM broadcast stations.

The road traffic information includes a congestion degree in each link; a necessary traveling time period in each link; or traffic regulation information such as traffic closer due to an accident or construction, or entrance/exit closure of expressways. The congestion degree is indicated using multiple evaluation levels such as congested, crowded, or empty. The received road traffic information is processed by the control circuit 10, and the congestion information or the traffic regulation information is shown on a screen of the display unit 12 while being overlapped on the road map.

The navigation device 100 includes a map display function for displaying a map including a current position and its surrounding area. When a user inputs a destination using the remote controller 18 via the remote controller sensor 17 or using the operation switch group 9, the device 100 automatically retrieves a route to the inputted destination from a starting point of the current position or the like. The device 100 then displays a road map based on advancement of the subject vehicle and guides the user to the destination. Thus, the device 100 includes a route guidance function. This automatic optimum route retrieval can be achieved using the known Dijkstra method.

Furthermore, the navigation device 100 includes a retrieval function for retrieving a position of a facility or the like. The retrieval function uses the index data and selects the following: an alphabetical retrieval using names of retrieval objects; an address retrieval using addresses of retrieval objects; a phone number retrieval using phone numbers of retrieval objects; or a genre retrieval using kinds of retrieval objects.

The retrieval function enables a facility or a point designated by a user to be registered as an entry point. The entry point is memorized or stored in the internal memory of the control circuit 10 or the external memory 11. For instance, when a user retrieves a position of a home of the user, the retrieved position of the home is memorized as an entry point. With respect to an entry point, a priority level (or priority order) in a route retrieval can be arbitrarily set in an entry point route guidance process to be explained later.

Next, a feature of the navigation device 100 will be explained below. The device 100 usually determines whether an access to the map database 8 is enabled every a given time period or every a given traveling distance, during executing the route guidance or the map display.

When the access to the map database 8 is determined to be enabled, the device 100 executes a route retrieval to the entry point from a current position every a given time period or every a given traveling distance, in addition to executing the route guidance or the map display. Route information related to the retrieved route is memorized in the external memory 11 or the internal memory of the control circuit 10. This enables the route retrieval to the entry point as an internal process (background process) during executing the route guidance or the map display, regardless of user's operation.

The route information is road data constituting the route to the entry point and is, therefore, minimum required data for the route guidance to the entry point. That is, the route information corresponds to the link data and node data constituting the route to the entry point. Storing or memorizing the road data constituting the route to the entry point as the route information can minimize data volume to be stored. This enables the entire route information to be stored even when a distance from the current position to the entry point increases.

Furthermore, in a case where there are multiple entry points and their priority levels are set, a route retrieval can be performed with respect to an entry point that has the highest priority level. This enables a route retrieval to the highest prioritized entry point.

In a case where multiple entry points including a home of the user are inputted but their priority levels are not set, a route retrieval can be performed with respect to the home as the entry point. This enables a route retrieval to the home of the user.

Furthermore, in a case where multiple entry points are inputted but their priority levels are not set, a route retrieval can be performed with respect to an entry point nearest to the current position. This enables a route retrieval to, among the registered entry points, an entry point nearest in a distance basis or in a time basis, from the current position. Alternatively, one of multiple entry points can be selected by a user when a route guidance to an entry point is started.

In contrast, when the access to the map database 8 is determined to be not enabled because of malfunction of the map database 8 or the like, the device 100 executes a route guidance to the entry point by using the route information stored in the external memory 11 or the internal memory of the control circuit 10.

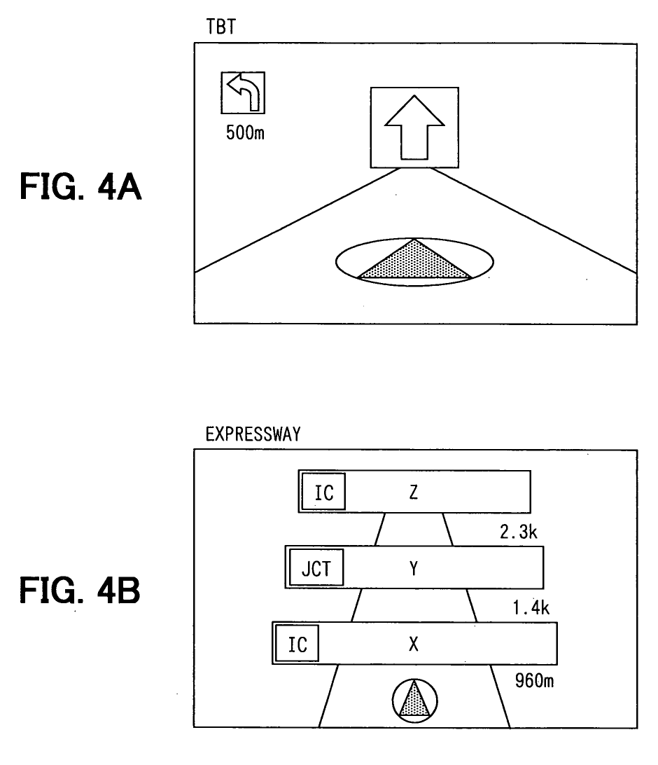

In this route guidance, map display cannot be used for the route guidance because of using only the road data constituting the route to the entry point. However, for instance, a route guidance using a turn-by-turn (TBT) mode can be achieved as shown in FIG. 4A. In the turn-by-turn mode, an arrow indicating a direction where the subject vehicle should advance is shown in addition to the current position, at a branching point, a merging point, or an intersection. Alternatively, a route guidance using an expressway mode can be achieved as shown in FIG. 4B. In the expressway mode, names of passing points (X, Y, Z in FIG. 4B) such as interchanges or junctions present in an advancing direction is shown in addition to the current position.

Here, the device 100 can be alternatively provided to display a map just only along the route to the entry point. In this case, map data corresponding to the map just only along the route should be stored in addition to the route information.

Thus, providing the names of the passing points or the direction where the subject vehicle should advance can guide the user to the entry point even when the access to the map database 8 is not enabled.

The route guidance to the entry point can be performed regardless of ON or OFF of accessory position (ACC) of an ignition key of the subject vehicle, as long as the device 100 connects to a power unit. However, the user can release the route guidance to the entry point.

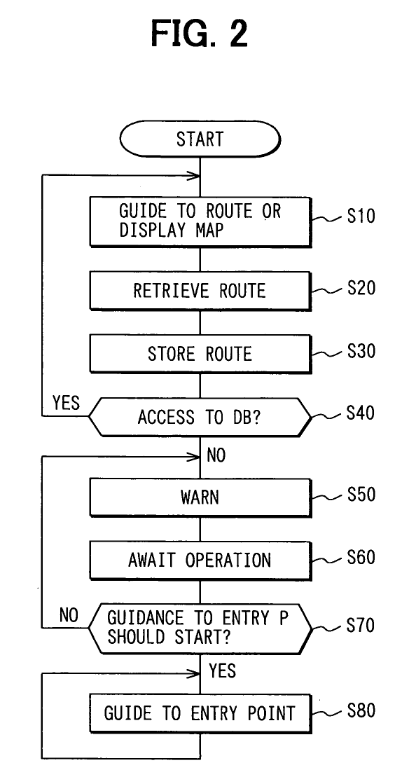

Next, an entry point route guidance process of the navigation device 100 will be explained with reference to FIG. 2. At Step S10, usual route guidance to a destination is performed while the route guidance function runs. Alternatively, a map including a current position and a surrounding area is displayed while the map display function runs.

At Step S20, a route to an entry point is retrieved as a background process of the usual route guidance or map display. When only one entry point is inputted or registered by a user in the route retrieval, a route to the only one entry point is retrieved. When multiple entry points are inputted in the route retrieval, a route to the most prioritized entry point is retrieved as long as the priority levels are assigned to the multiple entry points.

When multiple entry points including a home of the user are present, a route to the home of the user is retrieved. Furthermore, when multiple entry points not including the home and their priority levels are not set, a route to the nearest (in time-basis or distance-basis) entry point from the current position is retrieved.

At Step S30, route information relating to the retrieved to the entry point is stored in the external memory 11 or the internal memory of the control circuit 10. At Step S40, it is determined whether an access to the map database 8 is possible (or enabled). When the access is determined to be possible, the sequence returns to Step S10 for repeating the process at Steps S10 to S30.

In contrast, when the access to the map database 8 is impossible or disabled, the sequence goes to Step S50. Here, a notice that a usual route guidance is not available is warned to the user by voice or display while the route guidance function runs. For instance, a message “Route guidance to destination stops because of malfunction of access to map database” is shown in a screen of the display unit 12 as shown in FIG. 3 or is outputted by voice. Furthermore, a notice that a map display is not available is warned to the user by voice or display while the map display function runs. For instance, a message “Map display stops because of malfunction of access to map database” is shown in a screen of the display unit 12 or is outputted by voice.

Moreover, while the route guidance function runs, a message asking whether a route guidance to an entry point should start is outputted by voice or display. For instance, this message is “Route guidance to entry point should start?” is shown in addition to the message indicating unavailability of the route guidance as shown in FIG. 3 or is outputted by voice.

Yet moreover, while the map display function runs, a message asking whether a route guidance to an entry point should start is outputted by voice or display, in addition to the massage indicating unavailability of the map display.

At Step S60, a user's operation (inputting operation of (YES/NO) is awaited. At Step S70, it is determined whether the user indicates start of the route guidance to an entry point.

When this determination at Step S70 is affirmed, or when the user inputs “YES,” the sequence goes to Step S80. Here, the route guidance to the entry point is started. This enables the route guidance to the entry point to be started based on the user's input or instruction.

In contrast, when the determination at Step S70 is negated, or when the user inputs “NO,” the sequence returns to Step S50. Here, the display shown in FIG. 3 continues. Alternatively, the route guidance may completely end.

As explained above, while an access to the map database 8 is enabled, the navigation device 100 of the embodiment constantly retrieves a route to an entry point designated by a user and stores route information relating to the retrieved route.

Thus, even when the access to the map database 8 becomes impossible or unavailable because of malfunction of the map database 8 or the like, the route information stored in the external memory 11 or the internal memory of the control circuit 10 can be used. Therefore, using the stored route information, guidance to the entry point from a position that is the last point where the access to the map database 8 is still available can be possible. This enables a route guidance to a point the user wants to approach, even when the access to the map database is not enabled.

(Other Modification)

The navigation device 100 of the embodiment uses map data of the map database 8 mounted in the subject vehicle to perform route retrieval to a destination or an entry point. However, a navigation device can alternatively use map data stored in a map database located outside of the subject vehicle through a communications method such as the communications unit 16 or the like. In such navigation device, at Step S40 in FIG. 2, it is determined whether an access to the outside of the subject vehicle via the communication unit 16 or the like is enabled.

The entry point route guidance process or programs executed by the control circuit 10 can be provided to the control circuit 10 of the navigation device 100 from a computer-readable medium via a known interfacing unit or a known communications network.

It will be obvious to those skilled in the art that various changes may be made in the above-described embodiments of the present invention. However, the scope of the present invention should be determined by the following claims.

What is claimed is:

1. A navigation device comprising:
a route retrieval unit that retrieves a route to a destination using map data stored in a map database;
a guidance unit that guides a user along the retrieved route to the destination;
an entry point storing unit that stores a point designated by the user as an entry point;
a determination unit that determines whether an access to the map database is enabled;
an entry point route retrieval unit that retrieves a route to the entry point using the map database when the access to the map database is determined to be enabled;
a route information storing unit that stores route information relating to the retrieved route; and
an entry point route guidance unit that guides the user along the retrieved route to the entry point using the stored route information when the access to the map database is determined to be not enabled.

2. The navigation device of claim 1,
wherein the route information storing unit stores as the route information road data constituting the route to the entry point, and
wherein the entry point route guidance unit guides the user along the retrieved route to the entry point by notifying at least one of (i) a direction to which the user should advance along the retrieved route to the entry point and (ii) a name of a passing point in the retrieved route to the entry point.

3. The navigation device of claim 1, further comprising:
a position detector that detects a current position; and
a map display unit that displays a map including the current position,
wherein the determination unit determines while the guidance unit guides or while the map display unit displays, and
wherein the entry point route retrieval unit retrieves while the guidance unit guides or while the map display unit displays.

4. The navigation device of claim 3, further comprising:
a notification unit that notifies a notice that route guidance to the destination is unavailable or map display is unavailable through at least one of a voice output or a display unit when the access to the map database is not enabled.

5. The navigation device of claim 4,
wherein the notification unit notifies, in addition to the notice that route guidance to the destination is unavailable or map display is unavailable, a notice that route guidance to the entry point is to start.

6. The navigation device of claim 5, further comprising:
an instruction unit that generates an instruction to cause route guidance to the entry point to start,
wherein the entry point route guidance unit starts to guide the user along the retrieved route to the entry point when the instruction is generated after the notification unit notifies the notice that route guidance to the entry point is to start.

7. The navigation device of claim 1,
wherein the entry point route retrieval unit retrieves a route to an entry point having a highest priority level when multiple entry points are stored and priority levels are assigned to each of the multiple entry points.

8. The navigation device of claim 1,
wherein, when multiple entry points including a home of the user are stored and priority levels are not assigned to each of the multiple entry points, the entry point route retrieval unit retrieves a route to the home.

9. The navigation device of claim 1,
wherein, when multiple entry points not including a home of the user are stored and priority levels are not assigned to each of the multiple entry points, the entry point route retrieval unit retrieves a route to, among the multiple entry points, a nearest entry point from the current position.

10. The navigation device of claim 1, further comprising:
a communications unit that communicates with an outside,
wherein the route retrieval unit and the entry point route retrieval unit retrieve a route using, via the communications unit, map data stored in a map database located in the outside, and
wherein the determination unit determines whether an access to the map database located in the outside is enabled.

11. A route guidance method used for a navigation device that retrieves a route to a destination using map data stored in a map database and guides a user along the retrieved route to the destination, the route guidance method comprising steps of:
storing an entry point designated by the user;
determining whether an access to the map database is enabled;
retrieving a route to the entry point using the map database when the access to the map database is determined to be enabled;
storing route information relating to the retrieved route to the entry point; and
guiding the user along the retrieved route to the entry point using the stored route information when the access to the map database is determined to be not enabled.

12. The route guidance method used for a navigation device of claim 11,
wherein, in the step of storing the entry point, the route information includes road data constituting the route to the entry point, and
wherein, in the step of guiding the user along the retrieved route to the entry point, the user is guided by notifying at least one of (i) a direction to which the user should advance along the retrieved route to the entry point and (ii) a name of a passing point in the retrieved route to the entry point.

13. The route guidance method used for a navigation device of claim 11, further comprising a step:
displaying a map including a current position,
wherein, in the step of determining, whether an access to the database is enabled is determined while the user is guided or while the map is displayed, and
wherein, in the step of retrieving a route to the entry point, a route to the entry point is retrieved while the user is guided or while the map is displayed.

14. The route guidance method used for a navigation device of claim 13, further comprising:
notifying a notice that route guidance to the destination is unavailable or map display is unavailable through at least one of a voice output or a display unit when the access to the map database is not enabled in the step of determining.

15. The route guidance method used for a navigation device of claim 14,
wherein, in the step of notifying, a notice that route guidance to the entry point is to start is notified in addition to the notice that route guidance to the destination is unavailable or map display is unavailable.

16. The route guidance method used for a navigation device of claim 15,
wherein, in the step of guiding the user to the retrieved route to the entry point, guiding the user is started when an instruction that causes route guidance to the entry point to start is generated after the notice that route guidance to the entry point is to start is notified.

17. The route guidance method used for a navigation device of claim 11,
wherein, in the step of retrieving a route to the entry point, a route to an entry point having a highest priority level is retrieved when multiple entry points are stored and priority levels are assigned to each of the multiple entry points.

18. The route guidance method used for a navigation device of claim 11,
wherein, in the step of retrieving a route to the entry point, when multiple entry points including a home of the user are stored and priority levels are not assigned to each of the multiple entry points, a route to the home is retrieved.

19. The route guidance method used for a navigation device of claim 11,
wherein, in the step of retrieving a route to the entry point, when multiple entry points not including a home of the user are stored and priority levels are not assigned to each of the multiple entry points, a route to, among the multiple entry points, a nearest entry point from the current position is retrieved.

20. The route guidance method used for a navigation device of claim 11,
wherein, in the step of determining, whether an access to a map database located in an outside via a communications unit is enabled is determined.

21. A computer program product in a computer-readable medium used for a navigation device that retrieves a route to a destination using map data stored in a map database and guides a user along the retrieved route to the destination, the computer program product comprising:
instructions of storing an entry point designated by the user;
instructions of determining whether an access to the map database is enabled;
instructions of retrieving a route to the entry point using the map database when the access to the map database is determined to be enabled;
instructions of storing route information relating to the retrieved route to the entry point; and
instructions of guiding the user along the retrieved route to the entry point using the stored route information when the access to the map database is determined to be not enabled.

22. The computer program product of claim 21,
wherein, in the instructions of storing the entry point, the route information includes road data constituting the route to the entry point, and
wherein, in the instructions of guiding the user along the retrieved route to the entry point, the user is guided by notifying at least one of (i) a direction to which the user should advance along the retrieved route to the entry point and (ii) a name of a passing point in the retrieved route to the entry point.

23. The computer program product of claim 21, further comprising:
instructions of displaying a map including a current position,
wherein, in the instructions of determining, whether an access to the database is enabled is determined while the user is guided or while the map is displayed, and
wherein, in the instructions of retrieving a route to the entry point, a route to the entry point is retrieved while the user is guided or while the map is displayed.

24. The computer program product of claim 23, further comprising:
notifying a notice that route guidance to the destination is unavailable or map display is unavailable through at least one of a voice output or a display unit when the access to the map database is not enabled in the instructions of determining.

25. The computer program product of claim 24,
wherein, in the instructions of notifying, a notice that route guidance to the entry point is to start is notified in addition to the notice that route guidance to the destination is unavailable or map display is unavailable.

26. The computer program product of claim 25,
wherein, in the instructions of guiding the user to the retrieved route to the entry point, guiding the user is started when an instruction that causes route guidance to the entry point to start is generated after the notice that route guidance to the entry point is to start is notified.

27. The computer program product of claim 21,
wherein, in the instructions of retrieving a route to the entry point, a route to an entry point having a highest priority level is retrieved when multiple entry points are stored and priority levels are assigned to each of the multiple entry points.

28. The computer program product of claim 21,
wherein, in the instructions of retrieving a route to the entry point, when multiple entry points including a home of the user are stored and priority levels are not assigned to each of the multiple entry points, a route to the home is retrieved.

29. The computer program product of claim 21,
wherein, in the instructions of retrieving a route to the entry point, when multiple entry points not including a home of the user are stored and priority levels are not assigned to each of the multiple entry points, a route to, among the multiple entry points, a nearest entry point from the current position is retrieved.

30. The computer program product of claim 21,
wherein, in the instructions of determining, whether an access to a map database located in an outside via a communications unit is enabled is determined.
